(19) United States
(12) Patent Application Publication
(10) Pub. No.: US 2026/0110708 A1
(43) Pub. Date: Apr. 23, 2026

(54) ULTRA-PRECISION ELECTRON DENSITY CONTROLLER

(71) Applicant: POSTECH RESEARCH AND BUSINESS DEVELOPMENT FOUNDATION, Pohang-si (KR)

(72) Inventors: Kyoung-Duck PARK, Pohang-si (KR); Hyeongwoo LEE, Pohang-si (KR); Sujeong KIM, Pohang-si (KR)

(21) Appl. No.: 19/290,631

(22) Filed: Aug. 5, 2025

(30) Foreign Application Priority Data
Oct. 18, 2024 (KR) 10-2024-0143388

(51) Int. Cl. G01Q 60/32; G01Q 60/10

(52) U.S. Cl. CPC G01Q 60/32; G01Q 60/10

(57) ABSTRACT

An ultra-precision electron density controller is disclosed. The ultra-precision electron density controller includes: a plate configured to support a sample; an electrode configured to be arranged at a distance of several nanometers from the sample; and a pulse signal control circuit configured to apply a pulse signal to the electrode to form an electric field, control the electric field by adjusting at least one parameter of the pulse signal, and control electron density of the sample through the electric field control. Such an ultra-precision electron density controller may ultra-precisely control electron density of the sample at the nanoscale and simultaneously measure electrical characteristics and optical characteristics.

### CROSS-REFERENCE TO RELATED APPLICATION

This application claims priority under 35 U.S.C § 119 to Korean Patent Application No 10-2024-0143388 filed on Oct. 18, 2024 in the Korean Intellectual Property Office, which is hereby incorporated by reference in its entirety.

### BACKGROUND

### Field

The present disclosure relates to an ultra-precision electron density controller.

### Description of Related Art

A conductive atomic force microscope is a device that analyzes the electrical characteristics of a substance through a metallic probe. A conductive atomic force microscope may operate in a general environment, but it is impossible to electrically control a substance at the nanoscale. In addition, since only the electrical characteristics can be measured, it is impossible to analyze the optical characteristics of nanoscale samples.

A scanning tunneling microscope is a device that analyzes the characteristics of a substance with a resolution of several nanometers using a tunneling current. The scanning tunneling microscope cannot operate in a general environment without a chamber, and since it controls the distance between the probe and the surface using the tunneling current, there are significant limitations on the samples that can be measured. Furthermore, it is difficult to apply an electric field independently of the tunneling current in a scanning tunneling microscope, and the tunneling current itself may alter the condition of the sample. Therefore, it is impossible to analyze the inherent electro-optical characteristics of a sample at the nanoscale.

### SUMMARY

Currently, in various technical fields such as semiconductors, an ultra-precision electron density control technology capable of ultra-precisely controlling electron density of a sample at the nanoscale and simultaneously measuring electrical characteristics and optical characteristics is required.

However, a conductive atomic force microscope technology may operate in a general environment, but cannot perform electrical control at the nanoscale. A scanning tunneling microscope technology may perform electrical control at the nanoscale, but cannot operate in a general environment, and has limitations on measurable samples, so its usability is highly limited.

The problem to be solved by the present disclosure is to provide an ultra-precision electron density controller capable of ultra-precisely controlling electron density of a sample at the nanoscale and simultaneously measuring electrical characteristics and optical characteristics.

The objects of the present disclosure are not limited to the above-mentioned objects, and other objects and advantages of the present disclosure that are not mentioned will be understood by the following description and will be more clearly understood by embodiments of the present disclosure. In addition, it will be easy to see that the objects and advantages of the present disclosure may be realized by the means and combinations thereof disclosed in the claims.

An ultra-precision electron density controller according to an embodiment of the present disclosure may include: a plate configured to support a sample; an electrode configured to be arranged at a distance of several nanometers from the sample; and a pulse signal control circuit configured to apply a pulse signal to the electrode to form an electric field, to control the electric field by adjusting at least one parameter of the pulse signal, and to control electron density of the sample through the electric field control.

In embodiments, the pulse signal control circuit may adjust at least one of amplitude, pulse width, and wavelength of the pulse signal applied to the electrode such that electrical control or optical control may be performed in a nanoscale region of the sample, or such that electric field control may be performed from the nanoscale region to a microscale region.

According to embodiments, the present disclosure may control an electric field with nanosecond-level precision to ultra-precisely control electron density of a sample at the nanoscale, and may measure electrical characteristics and optical characteristics of the sample.

In addition, the present disclosure may operate in a general environment, may have no limitations on measurable samples, may enable electrical control at the nanoscale, and may allow analysis of optical characteristics. Therefore, through ultra-precision electron density control, electron doping may be performed on regions of various materials and devices at the several tens of nanometers scale, and through this, electron doping of semiconductors may be performed while simultaneously conducting electrical and optical analyses. As a result, semiconductors may be analyzed at the several tens of nanometers scale, making the present disclosure applicable to semiconductor miniaturization nano processes.

Furthermore, since the present disclosure may ultra-precisely control electron density in a nanoscale region, it enables electrical doping, measurement of changes in electrical characteristics, and measurement of changes in optical characteristics in the nanoscale region of a sample. Such ultra-precision electron density control is an essential technology for the development of nano optoelectronic devices and the realization of semiconductor nano processes.

The changes in electrical characteristics (electron density and conductivity) and optical characteristics (quantum yield and wavelength) of a two-dimensional transition metal chalcogenide compound shown as an embodiment of the present disclosure demonstrate that it is possible to control electron density of various low-dimensional quantum materials and simultaneously control optical and electrical characteristics in a general condition of room temperature and atmospheric pressure.

In addition, the present disclosure may be applied to semiconductor devices using electron density and to materials in which electron density plays an important role in material properties, such as graphene.

Moreover, the present disclosure is expected to be applicable in the future to fields requiring electrical control, electrical analysis, or optical analysis of semiconductors, ferroelectrics, and low-dimensional materials, fields requiring electrical and optical variation control and analysis at the nanoscale, or fields requiring electrical and optical analysis of optoelectronic devices.

In addition to the aforementioned effects, specific effects of the present disclosure will be described in detail together with specific matters for carrying out the disclosure.

### BRIEF DESCRIPTION OF THE DRAWINGS

FIG. 1 is a diagram illustrating a change in electron density of a sample according to electric field control of an ultra-precision electron density controller according to an embodiment of the present disclosure.

FIG. 2 illustrates a bias for electric field control of an ultra-precision electron density controller according to an embodiment of the present disclosure.

FIG. 3A is a diagram showing changes in electrical characteristics and optical characteristics of a sample according to the operation of an ultra-precision electron density controller according to an embodiment of the present disclosure.

FIGS. 3B and 3C illustrate changes in electron density according to bias application of an ultra-precision electron density controller according to an embodiment of the present disclosure.

FIG. 4A is a diagram showing that light emission characteristics of MoS₂, which is a two-dimensional transition metal chalcogenide compound, are electrically controlled by controlling electron density through an ultra-precision electron density controller according to an embodiment of the present disclosure.

FIG. 4B is a diagram showing results of measuring electrical characteristics and optical characteristics of MoS₂ while expanding a region in which electron density is controlled from a nanoscale region to a microscale region through an ultra-precision electron density controller according to an embodiment of the present disclosure.

FIG. 4C is a diagram showing active and repeated control of light emission characteristics of MoS₂ through an ultra-precision electron density controller according to an embodiment of the present disclosure.

FIG. 4D is a diagram illustrating changes in an electron density control region and corresponding changes in optical characteristics of MoS₂ according to ultrafast electric field control in an ultra-precision electron density controller according to an embodiment of the present disclosure.

FIG. 4E is a diagram showing active and repeated control of light emission characteristics of MoS₂ according to the electron density control region in an ultra-precision electron density controller according to an embodiment of the present disclosure.

### DETAILED DESCRIPTION

The above-described objects, means, and effects will be described in detail below with reference to the accompanying drawings, and thus, a person having ordinary skill in the art to which the present disclosure pertains may easily implement the technical spirit of the present disclosure. In the description of the present disclosure, detailed descriptions of known technologies related to the present disclosure will be omitted when it is determined that such descriptions may unnecessarily obscure the gist of the present disclosure. Hereinafter, preferred embodiments of the present disclosure will be described in detail with reference to the accompanying drawings. In the drawings, the same reference numerals are used to denote the same or similar components.

The following discloses an ultra-precision electron density controller capable of ultra-precisely controlling electron density of a sample at the nanoscale and simultaneously measuring electrical characteristics and optical characteristics.

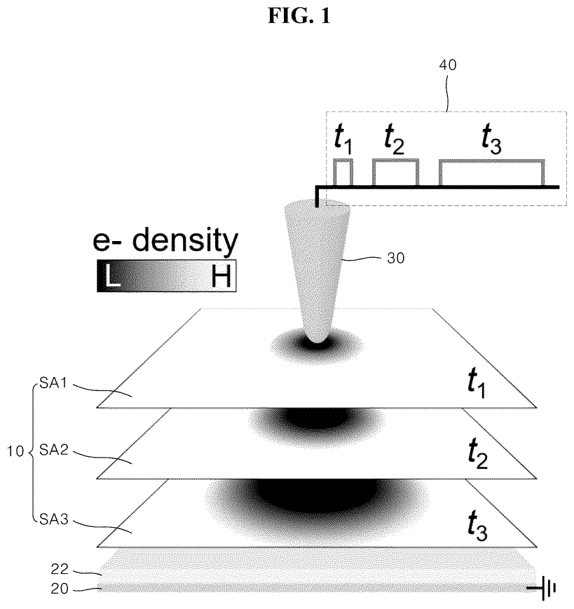

FIG. 1 is a diagram illustrating a change in electron density of a sample according to electric field control of an ultra-precision electron density controller according to an embodiment of the present disclosure.

Referring to FIG. 1, an ultra-precision electron density controller according to an embodiment of the present disclosure includes a plate 20, an electrode 30, and a pulse signal control circuit 40.

The plate 20 supports a sample 10 to be analyzed. The plate 20 is made of a metallic material. For example, the plate 20 may be made of at least one of gold (Au), silver (Ag), aluminum (Al), copper (Cu), cobalt (Co), chromium (Cr), platinum (Pt), palladium (Pd), rhodium (Rh), titanium (Ti), and nickel (Ni). The plate 20 may be connected to a ground terminal, and a ground voltage may be applied to the ground terminal.

A dielectric 22 may be formed on the plate 20. The dielectric 22 may be a material having a high dielectric constant. The dielectric 22 having a high dielectric constant may be formed on the plate 20, and the sample 10 to be analyzed may be mounted on the dielectric 22.

The sample 10 is a substance to be analyzed and may have a size of several nanometers. In the present embodiments, molybdenum disulfide monolayer (MoS₂ ML), which is a two-dimensional transition metal chalcogenide compound, is illustrated as the sample 10, but the sample is not limited thereto. The sample 10 may be any material in which electrons exist. For example, the sample 10 may be a semiconductor wafer, which is a thinly sliced circular plate of silicon used as a base material for producing semiconductor chips.

The electrode 30 may be formed in the shape of a nanoscale probe. A lower end of the electrode 30 may be arranged at a distance of several nanometers (nm) from the sample 10. The electrode 30 may be installed on a distance control device (not shown). The distance control device may adjust a distance between the sample 10 and the electrode 30 according to analysis conditions of the sample 10.

The electrode 30 may be made of a metallic material. For example, the electrode 30 may be made of at least one of gold (Au), silver (Ag), aluminum (Al), copper (Cu), cobalt (Co), chromium (Cr), platinum (Pt), palladium (Pd), rhodium (Rh), titanium (Ti), and nickel (Ni). A pulse signal may be applied to the electrode 30 from the pulse signal control circuit 40.

When analyzing the sample 10, a ground voltage may be applied to the plate 20, and a pulse signal may be applied to the electrode 30, so that an electric field may be formed between the plate 20 and the electrode 30 by the pulse signal. The electric field may be controlled by adjusting at least one parameter of the pulse signal, for example, at least one of amplitude, pulse width, and wavelength of the pulse signal.

The pulse signal control circuit 40 may apply a pulse signal to the electrode 30 to form an electric field. In this case, the pulse signal control circuit 40 may adjust at least one of the parameters of the pulse signal, such as amplitude, pulse width, and wavelength, according to the characteristics of the sample 10 or analysis conditions.

The pulse signal control circuit 40 may control an electric field by adjusting at least one of amplitude, pulse width, and wavelength of a pulse signal and applying it to the electrode 30, and may ultra-precisely control electron density of the sample 10 at the nanoscale through the electric field control.

In addition, the pulse signal control circuit 40 may apply the pulse signal in preset time units. For example, the pulse signal may be applied in units from femtoseconds to several seconds. Of course, this numerical range is not limited thereto. Such time units may be adjusted according to characteristics of the sample or analysis conditions.

The pulse signal control circuit 40 may adjust at least one of amplitude, pulse width, and wavelength of a pulse signal according to characteristics of the sample.

For example, the pulse signal control circuit 40 may control the pulse width of the pulse signal to be in nanoseconds (ns) and apply the signal to the electrode 30 so that electrical control or optical control may be performed in a nanoscale region of the sample.

In addition, the pulse signal control circuit 40 may control the pulse width of the pulse signal from nanoseconds to several seconds and apply the signal to the electrode 30 so that electric field control may be performed from a nanoscale region to a region of several millimeters.

Further, the pulse signal control circuit 40 may control an electric field by adjusting the pulse width of the pulse signal to be in nanoseconds (ns) and applying the signal to the electrode 30 such that electrical characteristics or optical characteristics of the sample may be measured according to changes in electron density of the sample.

The pulse signal control circuit 40 may also apply the pulse signal at intervals of several tens of nanoseconds. The pulse signal control circuit 40 may adjust a doping range for the sample 10 by adjusting the pulse width of the pulse signal. For example, the pulse signal control circuit 40 may apply a pulse signal having a nanosecond (ns)-level pulse width to the electrode so that doping may be performed in a nanoscale region of the sample. In addition, the pulse signal control circuit 40 may apply a pulse signal having a pulse width of several seconds to the electrode so that doping may be performed on the entire region of the sample 10.

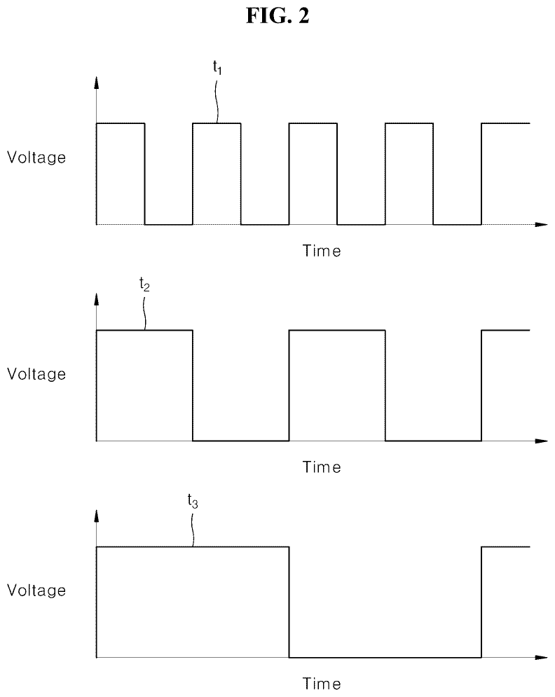

FIG. 2 illustrates a bias for electric field control of an ultra-precision electron density controller according to an embodiment of the present disclosure. The bias applied to the electrode 30 may be applied in the form of a pulse.

Referring to FIGS. 1 and 2, the electric field may be controlled according to the pulse widths of a first pulse signal t1, a second pulse signal t2, and a third pulse signal t3. Electron density of the sample 10 may be changed according to electric field control. FIGS. 1 and 2 illustrate adjusting the pulse width and wavelength (or period) of the pulse signal.

A second pulse signal t2 is illustrated as having a greater pulse width than a first pulse signal t1, and a third pulse signal t3 is illustrated as having a greater pulse width than the second pulse signal t2. As shown in FIG. 1, as the pulse width of the pulse signal increases, the electron density region controlled in the sample 10 may become larger. In addition, as the pulse width of the pulse signal increases, a high-electron density region in the sample 10 may also become larger.

For example, by applying a first pulse signal (t1), a second pulse signal (t2), and a third pulse signal (t3) to a first sample (SA1), a second sample (SA2), and a third sample (SA3) which are the same sample (10), it is possible to analyze changes in the electron density region in the same sample (10) according to adjustment of the pulse width of the pulse signal.

For example, a first pulse signal t1 may be applied to a first sample SA1, a second pulse signal t2 having a greater pulse width than the first pulse signal t1 may be applied to a second sample SA2, and a third pulse signal t3 having a greater pulse width than the second pulse signal t2 may be applied to a third sample SA3.

Further, electron density of the sample 10 may be changed by adjusting at least one of amplitude, pulse width, and wavelength of the pulse signal according to the electron density required for analysis of the sample 10.

Meanwhile, In FIG. 2, the amplitude of the pulse signal is illustrated as being the same, but the present disclosure is not limited thereto. The amplitude of the pulse signal may also be adjusted according to the electron density required for analysis of the sample 10.

In addition, the ultra-precision electron density controller can be applied to various samples, and can be used to control the electron density of various samples by controlling at least one of the amplitude, pulse width, and wavelength of the pulse signal according to the characteristics of the sample.

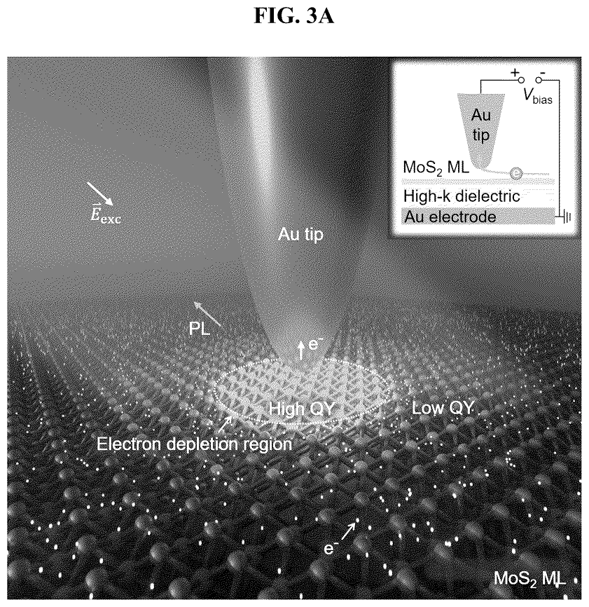

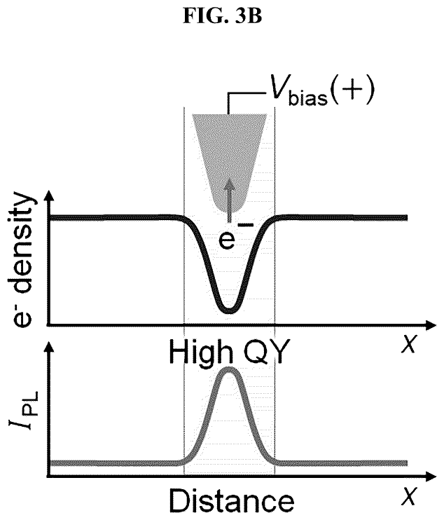

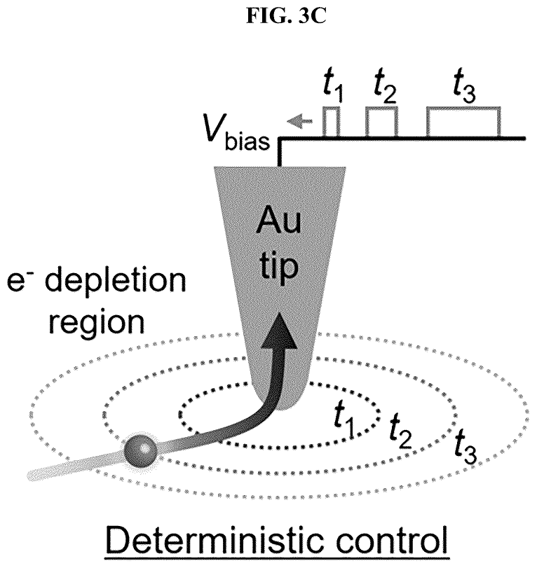

FIG. 3A is a diagram showing changes in electrical characteristics and optical characteristics of a sample according to the operation of an ultra-precision electron density controller according to an embodiment of the present disclosure. FIGS. 3B and 3C illustrate changes in electron density according to bias application of an ultra-precision electron density controller according to an embodiment of the present disclosure.

The ultra-precision electron density controller simultaneously controls electron density with ultra-precision in a nanoscale region and observes electrical and optical phenomena with nanoscale spatial resolution. The ultra-precision electron density controller measures optical characteristics while simultaneously controlling and measuring electrical characteristics.

For example, to control electrical characteristics, a nanoscale pulse signal control circuit may be configured by combining an ultrafast pulse signal control circuit and a nanoscale metallic probe. The pulse signal control circuit may adjust the application time of the electric field in nanoseconds, thereby enabling ultra-precision control of electron density in a nanoscale region.

As shown in FIG. 3A, a device in which MoS₂ ML and a dielectric having a high dielectric constant are combined is an example of a measurable sample, and quantum yield (QY), which is one of the optical characteristics of the sample, changes depending on the ultra-precise electron density. In this way, the electrical characteristics and optical characteristics of the sample change according to the operation of the ultra-precision electron density controller. In addition, as shown in FIGS. 3A, 3B, and 3C, electron density changes according to the bias applied by the ultra-precision electron density controller.

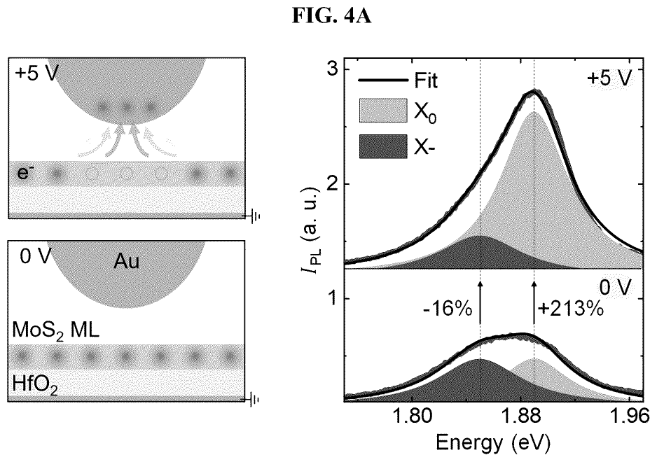

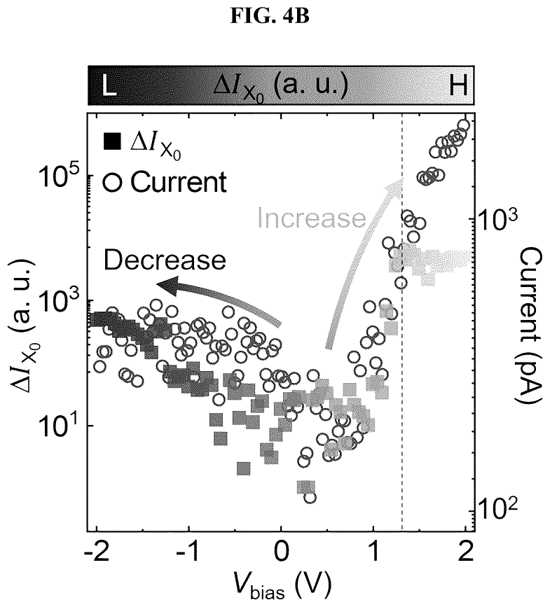

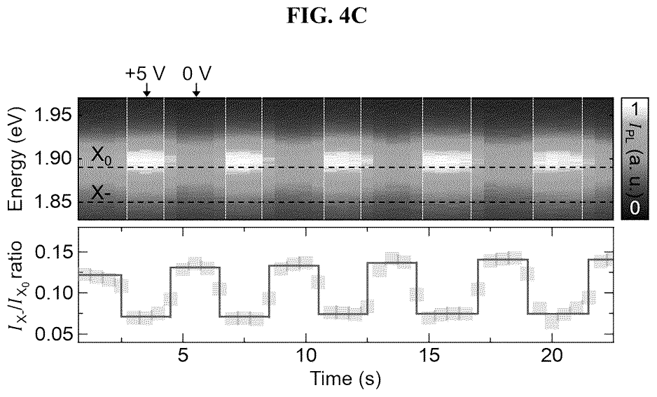

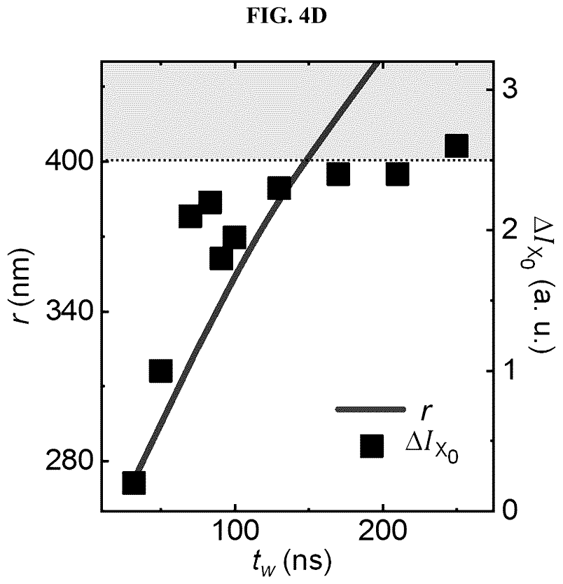

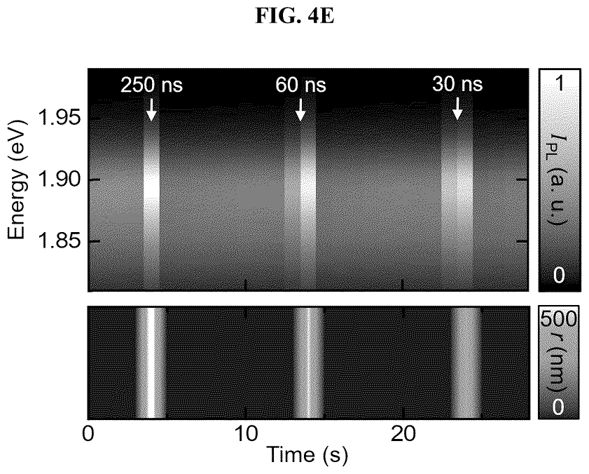

FIG. 4A is a diagram showing that light emission characteristics of MoS₂, which is a two-dimensional transition metal chalcogenide compound, are electrically controlled by controlling electron density through an ultra-precision electron density controller according to an embodiment of the present disclosure.

As shown in FIG. 4A, light emission characteristics of MoS₂, which is a two-dimensional transition metal chalcogenide compound, may be electrically controlled by controlling electron density of a sample through the ultra-precision electron density controller. In addition, changes in optical characteristics of MoS₂ may be compared when electron density of MoS₂ is decreased and increased through the ultra-precision electron density controller.

FIG. 4B is a diagram showing results of measuring electrical characteristics and optical characteristics of MoS₂ while expanding a region in which electron density is controlled from a nanoscale region to a region of several millimeters through the ultra-precision electron density controller according to an embodiment of the present disclosure. Electrical characteristics and optical characteristics of MoS₂ may be changed while expanding the region in which electron density is controlled from a nanoscale region to a region of several millimeters.

FIG. 4C is a diagram showing active and repeated control of light emission characteristics of MoS₂ through an ultra-precision electron density controller according to an embodiment of the present disclosure. By repeatedly applying a bias of +5V and 0V with a constant period through the ultra-precision electron density controller, light emission characteristics of MoS₂ may be actively and repeatedly controlled.

FIG. 4D is a diagram illustrating changes in an electron density control region and corresponding changes in optical characteristics of MoS₂ according to ultrafast electric field control in an ultra-precision electron density controller according to an embodiment of the present disclosure. It may be confirmed that changes in the electron density control region and corresponding changes in optical characteristics of MoS₂ occur according to ultrafast electric field control.

FIG. 4E is a diagram showing active and repeated control of light emission characteristics of MoS₂ according to the electron density control region in an ultra-precision electron density controller according to an embodiment of the present disclosure. It may be confirmed that light emission characteristics of MoS₂ are actively and repeatedly controlled according to the electron density control region.

Meanwhile, the ultra-precision electron density controller may be used in at least one of related fields including semiconductor devices, electrical and optical devices based on low-dimensional materials, scanning tunneling microscopes, conductive atomic force microscopes, piezoresponse force microscopes, pulse electric field generators, photoluminescence analyzers, electrical and optical devices based on nanomaterials, resistive random-access memories, field-effect transistors, and optoelectronic devices.

An ultra-precision electron density controller according to an embodiment of the present disclosure may include: a plate configured to support a sample; an electrode configured to be arranged at a distance of several nanometers from the sample; and a pulse signal control circuit configured to apply a pulse signal to the electrode to form an electric field, to control the electric field by adjusting at least one parameter of the pulse signal, and to control electron density of the sample through the electric field control.

According to some embodiments of the present disclosure, the pulse signal control circuit may apply the pulse signal in nanosecond units.

According to some embodiments of the present disclosure, the pulse signal control circuit may adjust at least one of amplitude, pulse width, and wavelength of the pulse signal according to characteristics of the sample.

According to some embodiments of the present disclosure, the pulse signal control circuit may control the pulse width of the pulse signal and apply the pulse signal at a nanosecond (ns) level so that electrical control or optical control may be performed in a nanoscale region of the sample.

According to some embodiments of the present disclosure, the pulse signal control circuit may control the pulse width of the pulse signal from nanoseconds (ns) to several seconds and apply it to the electrode so that electric field control may be performed from a nanoscale region to a region of several millimeters.

According to some embodiments of the present disclosure, the pulse signal control circuit may control an electric field by adjusting the pulse width of the pulse signal to a nanosecond (ns) level and applying the signal to the electrode so that electrical characteristics or optical characteristics of the sample may be measured according to changes in electron density of the sample.

According to some embodiments of the present disclosure, the pulse signal control circuit may apply the pulse signal at intervals of several tens of nanoseconds.

According to some embodiments of the present disclosure, the plate may be made of a metallic material, a dielectric having a high dielectric constant may be formed on the plate, and the sample to be analyzed may be mounted on the dielectric.

According to some embodiments of the present disclosure, the plate may be connected to a ground terminal, and a ground voltage may be applied to the ground terminal.

According to some embodiments of the present disclosure, the electrode may be made of a metallic material and may have a nanoscale probe shape.

According to an embodiment of the present disclosure, the pulse signal control circuit may adjust a doping range for the sample by adjusting a pulse width of the pulse signal and applying it to the electrode.

According to an embodiment of the present disclosure, the pulse signal control circuit may apply a pulse signal having a nanosecond (ns) level pulse width to the electrode so that doping may be performed in a nanoscale region of the sample.

According to an embodiment of the present disclosure, the pulse signal control circuit may apply a pulse signal having a pulse width of several seconds to the electrode so that doping may be performed over an entire region of the sample.

According to some embodiments of the present disclosure, the present disclosure may control an electric field at the nanosecond level to ultra-precisely control electron density of a sample at the nanoscale and simultaneously measure electrical characteristics and optical characteristics.

In addition, the present disclosure may operate in a general environment, may have no limitations on measurable samples, may enable electrical control at the nanoscale, and may allow analysis of optical characteristics. Therefore, through ultra-precision electron density control, electron doping may be performed on regions of various materials and devices at the several tens of nanometers scale, and through this, electron doping of semiconductors may be performed while simultaneously conducting electrical and optical analyses. As a result, semiconductors may be analyzed at the several tens of nanometers scale, making the present disclosure applicable to semiconductor miniaturization nano processes.

In addition, the present disclosure may ultra-precisely control electron density in a nanoscale region, thereby enabling electrical doping, measurement of changes in electrical characteristics, and measurement of changes in optical characteristics in the nanoscale region of a sample. Such ultra-precision electron density control is an essential technology for the development of nano optoelectronic devices and the realization of semiconductor nano processes.

The changes in electrical characteristics (electron density and conductivity) and optical characteristics (quantum yield and wavelength) of a two-dimensional transition metal chalcogenide compound shown as an embodiment of the present disclosure demonstrate that it is possible to control electron density of various low-dimensional quantum materials and simultaneously control optical and electrical characteristics in a general condition of room temperature and atmospheric pressure.

In addition, the present disclosure may be applied to semiconductor devices using electron density and to materials in which electron density plays an important role in material properties, such as graphene.

Furthermore, the present disclosure is expected to be applicable to fields requiring electrical control, electrical analysis, or optical analysis of semiconductors, ferroelectrics, and low-dimensional materials; fields requiring electrical and optical variation control and analysis at the nanoscale; or fields requiring electrical and optical analysis of optoelectronic devices.

Although the present disclosure has been described above with reference to the illustrated drawings by way of example, it is apparent that the present disclosure is not limited to the embodiments and drawings disclosed in the present specification, and that various modifications may be made by a person having ordinary skill in the art within the scope of the technical idea of the present disclosure. In addition, even if the operational effects according to the configuration of the present disclosure are not explicitly described when describing the above embodiments of the present disclosure, predictable effects resulting from the configuration must also be recognized.

What is claimed is:

1. An ultra-precision electron density controller comprising:
a plate configured to support a sample;
an electrode configured to be arranged at a distance of several nanometers from the sample; and
a pulse signal control circuit configured to apply a pulse signal to the electrode to form an electric field, to control the electric field by adjusting at least one parameter of the pulse signal, and to control electron density of the sample through the electric field control.

2. The ultra-precision electron density controller according to claim 1,
wherein the pulse signal control circuit is configured to apply the pulse signal in preset time units.

3. The ultra-precision electron density controller according to claim 1,
wherein the pulse signal control circuit is configured to adjust at least one of amplitude, pulse width, and wavelength of the pulse signal according to characteristics of the sample.

4. The ultra-precision electron density controller according to claim 1,
wherein the pulse signal control circuit is configured to control the pulse width of the pulse signal to a nanosecond level and apply it to the electrode such that electrical control or optical control of the sample is performed.

5. The ultra-precision electron density controller according to claim 1,
wherein the pulse signal control circuit is configured to adjust the pulse width of the pulse signal from nanoseconds to several seconds and apply it to the electrode such that electric field control is performed from a nanoscale region to a region of several millimeters.

6. The ultra-precision electron density controller according to claim 1,
wherein the pulse signal control circuit is configured to control the electric field by adjusting a pulse width of the pulse signal to a nanosecond level and applying it to the electrode such that electrical characteristics or optical characteristics of the sample are measured according to changes in electron density of the sample.

7. The ultra-precision electron density controller according to claim 1,
wherein the pulse signal control circuit is configured to apply the pulse signal at preset intervals.

8. The ultra-precision electron density controller according to claim 1,
wherein the plate is made of a metallic material, a dielectric having a high dielectric constant is formed on the plate, and the sample to be analyzed is mounted on the dielectric.

9. The ultra-precision electron density controller according to claim 8,
wherein the plate is connected to a ground terminal, and a ground voltage is applied to the ground terminal.

10. The ultra-precision electron density controller according to claim 1, wherein the electrode is made of a metallic material and has a nanoscale structure.

11. The ultra-precision electron density controller according to claim 1,
wherein the pulse signal control circuit is configured to adjust a doping range for the sample by adjusting a pulse width of the pulse signal and applying it to the electrode.

12. The ultra-precision electron density controller according to claim 11,
wherein the pulse signal control circuit is configured to apply the pulse signal having a nanosecond-level pulse width to the electrode such that doping of the sample is performed in a nanoscale region.

13. The ultra-precision electron density controller according to claim 11,
wherein the pulse signal control circuit is configured to apply the pulse signal having a pulse width of several seconds to the electrode such that doping of the entire region of the sample is performed.
